(19) United States
(12) Patent Application Publication
(10) Pub. No.: US 2006/0104506 A1
(43) Pub. Date: May 18, 2006

(54) Apparatus for processing an image and for character recognition in a mobile communication terminal, and method thereof

(75) Inventor: Yu Nam Kim, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/280,580

(22) Filed: Nov. 15, 2005

(30) Foreign Application Priority Data
Nov. 15, 2004 (KR) 10-2004-0092905

(51) Int. Cl. G06K 9/00; G06K 9/36

(52) U.S. Cl. 382/162; 382/276

(57) ABSTRACT

An apparatus for processing inversion of image and method thereof are disclosed by which character information can be acquired through an image inversion processing. The present invention includes a video processing unit calculating a critical value according to luminosity data of the image, an inversion decision unit dividing the luminosity data into two classes using the critical value, wherein the inversion decision unit decides whether an image is inverted, and an inverting unit for inverting the luminosity data of the image according to whether the image is inverted.

### CROSS-REFERENCE TO RELATED APPLICATIONS

Pursuant to 35 U.S.C. § 119(a), this application claims the benefit of the Korean Application No. 10-2004-0092905 filed on Nov. 15, 2004, which is hereby incorporated by reference.

### FIELD OF THE INVENTION

The present invention relates to an apparatus for inverting an image and method thereof. Although the present invention is suitable for a wide scope of applications, it is particularly suitable for acquiring information such as characters and the like through an image inversion process.

### BACKGROUND OF THE INVENTION

Recently, character recognition for interpreting textual characters and information is widely used. Examples include devices such as a business card reader, a document classifier, a sale-slip regulator, and a mail sorter. Each of these employs optical character recognition in general.

The optical character recognition translates a character image into a character code such as ASCII by scanning a text and analyzing each character in a row of the text to enable digital data processing. To identify characters, the optical character recognizer reads a document using a scanner, analyzes dark and bright parts of an image, and then converts the recognized characters into ASCII codes.

A mobile communication terminal such as a cellular phone, a PDA, or a smart phone is provided with a camera. Also, various products are manufactured having an optical character recognition for recognizing characters from an image photographed by a camera.

However, optical character recognition is more accurate when dark characters are presented on a bright background. Often, optical character recognition is unable to properly identify light characters on a dark background.

### SUMMARY OF THE INVENTION

Accordingly, the present invention is directed to an apparatus for inverting an image and method thereof that substantially solves one or more problems due to limitations and disadvantages of the related art.

An object of the present invention is to provide an apparatus for inverting an image and method thereof, by which information such as characters and the like can be acquired through an image inversion processing.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus for image inversion according to the present invention comprises a video processing unit calculating a critical value according to luminosity of video data, an inversion decision unit dividing the video data into two classes according to the luminosity using the critical value, wherein the inversion decision unit decides whether to invert an image according to distributions of the two classes, and an inverting unit performing the inversion process on the video data according to the inversion decision.

In another aspect of the present invention, a method of inverting an image comprises the steps of calculating a critical value according to luminosity by applying global binary algorithm to video data, comparing a distribution area of the video data according to the luminosity, deciding whether to invert an image according to the distribution area of the video data, and inverting the video data luminosity.

In a further aspect of the present invention, an apparatus for acquiring information in a mobile communication terminal comprises a video input unit for converting an image from a lens to video data, a video output unit for displaying the image, a preview unit for receiving the video data from the video input unit and providing the video data to the video output unit, a video processing unit for receiving the video data from the preview unit and for determining a critical value according to luminosity and for dividing the video data into two classes according to the critical value, an inversion decision unit calculating a distribution area according to the luminosity of the video data and deciding to invert an image, a photograph selection unit for selecting the inputted image, an inverting unit for inverting the image photographed by the photograph selection according to the inversion decision unit, and a character recognition unit acquiring character information of the image from the inverting unit.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a mobile communication terminal including an image inverting apparatus according to the present invention;

FIG. 2 is a diagram of an image of a general document having a background area of which brightness is higher than that of a character area;

FIG. 3 is a diagram of an image of an inverted document having a background area of which brightness is less than that of a character area;

FIG. 4 is a diagram of a histogram distribution for an image of the general document shown in FIG. 2 and a critical value having Otsu algorithm applied thereto;

FIG. 5 is a diagram of a histogram distribution for an image of the inverted document shown in FIG. 3 and a critical value having Otsu algorithm applied thereto;

FIG. 6 is a graph of histogram distributions of images of general and inverted documents and critical values calculated through Otsu algorithm; and

FIG. 7 is a flowchart of a method of inverting an image according to an embodiment of the present invention.

### DETAILED DESCRIPTION OF THE EMBODIMENTS

Reference will now be made in detail to embodiments of the present invention, examples of which are illustrated in the accompanying drawings. Wherever possible, the same reference numbers will be used throughout the drawings to refer to the same or like parts.

An apparatus for inverting an image and method thereof are disclosed in the following description. In particular, the present invention can quickly acquire character information from an image having background and character luminance inverted, wherein the image is photographed using a camera provided to a mobile communication terminal.

Recognizing characters from an image photographed by a mobile communication terminal is generally applicable to business card recognition, and business cards may provide information that lends itself to character recognition.

The present invention provides an apparatus for inverting an image and method thereof applicable to a mobile communication terminal by deciding whether to invert an image based upon simple calculations.

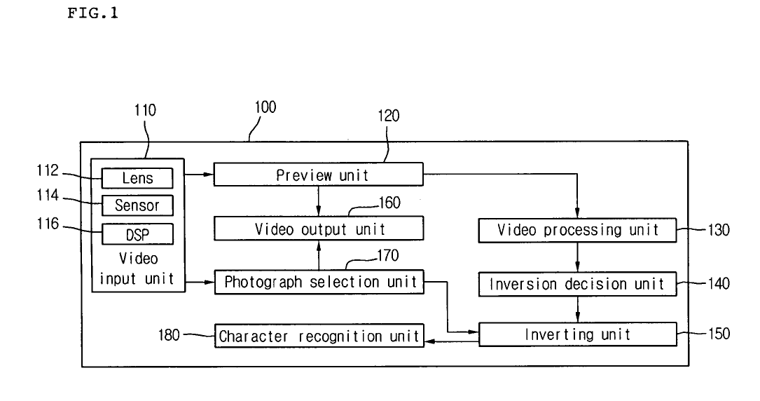

FIG. 1 is a block diagram of a mobile communication terminal including an inversion processing apparatus according to the present invention, wherein, a mobile communication terminal 100 includes a video input unit 110, a preview unit 120, a photograph selection unit 170, a video output unit 160, a video processing unit 130, an inversion decision unit 140, an inverting unit 150 and a character recognition unit 180.

The video input unit 110 includes a lens 112, a sensor 114 and a digital signal processor (DSP) 116. An image focused on the lens 112 is sensed as a light signal via the sensor 114 to be converted to video data having a color space via the DSP 116.

The preview unit 120 receives the video data from the video input unit 110 to provide a video of 15-frames per second to the video output unit 160, and the preview unit 120 transfers a series of frames to the video processing unit 130 so that the video of the respective frames can be image-processed.

The video output unit 160 may include an LCD panel to control the video. Once a series of the video frames are provided from the preview unit 120, the video output unit 160 displays the provided video frames so that a user can select a photographed image. In this case, the user selects the photographed image via the photograph selection unit 170. The video output unit 160 displays the photographed image to enable the user to check the displayed image.

The photograph selection unit 170 includes a selector button to provide the video data selected by the user to the inverting unit 150.

The video processing unit 130 receives a series of the video data from the preview unit 120 to calculate a histogram of the video and then applies a global binary algorithm thereto. Namely, the video processing unit 130 calculates a critical value according to brightness of the video data by applying the global binary algorithm to the video data and then categorizes the data into one of two classes according to the brightness of the video data represented by the critical value.

Since a video image having characters does not have a gradual brightness value in general, the video processing unit 130 uses the global binary algorithm. The Otsu algorithm is a representative example of the global binary algorithm.

The Otsu algorithm divides the video data into two classes according to luminosity by a single threshold and performs optimal thresholding on all pixels of the video data, thereby maximizing a difference between the two classes. The Otsu algorithm uses inter-class variance to obtain a histogram from video data and selects a level having a greatest variance between a character class and a background class from the histogram as a critical value.

Assuming that ω₀ and ω₁ are occurrence probabilities of the classes for a luminosity level (1, 2, 3, . . . k, L) and that μ₀ and μ₁ are average levels of the classes, respectively, an inter-class variance σ²_{B}(k) for the level k can be defined as Formula 1.
σ²_{B}(k)=ω₀ω₁(μ₁−μ₀)² [Formula 1]

Hence, the value is found for each of the L-levels and ‘k*’ having a maximum is then found among the found values according to Formula 2 to use as a critical value.
σ²_{B}(k*)=Max_{1≦k≦L}(σ_{B}²(k)) [Formula 2]

Such a method is free from parameters, facilitates implementation, has a fast speed, and divides all video into two classes. Therefore, such a method operates efficiently.

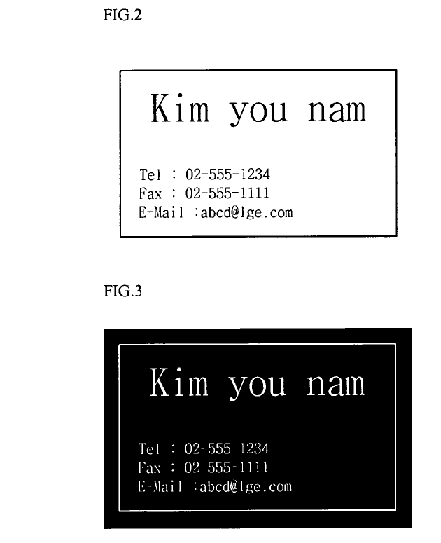

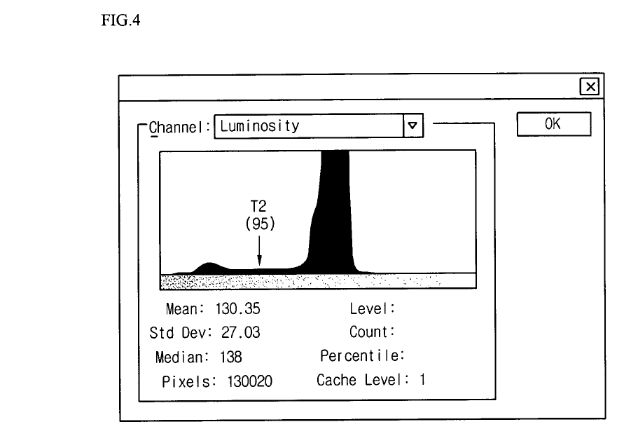

FIG. 2 is a diagram of an image of a general document having a background area brighter than a character area and FIG. 3 is a diagram of an image of an inverted document wherein the character area is brighter than the background area.

FIG. 4 is a histogram distribution for an image of the general document shown in FIG. 2 and the Otsu algorithm is applied to determine a critical value. FIG. 5 is a histogram distribution for the inverted image of the document shown in FIG. 3 and a critical value is shown.

Referring to FIG. 5, the critical value is 160 (T1) among 256 levels of luminosity in the image of the inverted document shown in FIG. 3.

The inversion decision unit 140 determines boundary points T1 and T2 on the histogram by the crucial value according to probability distribution and calculates distribution areas of the two classes centering on the boundary point.

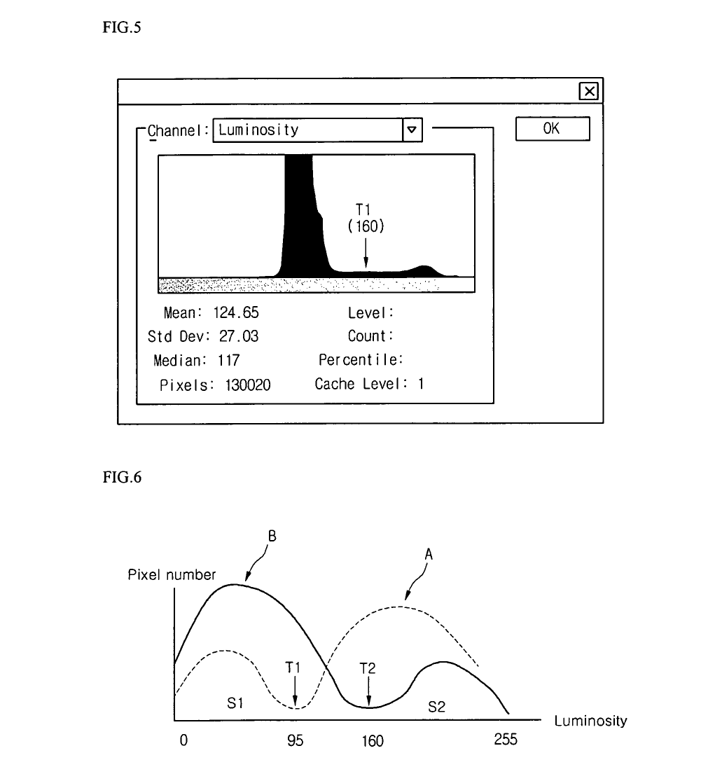

FIG. 6 is a graph of histogram distributions of images of the general and inverted documents and critical values calculated using the Otsu algorithm, in which the x-axis represents luminosity and the y-axis represents a pixel number of image.

For the general image of FIG. 2, the inversion decision unit 140 calculates distribution areas of two classes centering on the critical value T1. In FIG. 6, curve A shows the luminosity histogram, wherein S1 is the area of histogram values between 0˜95 and S2 is the area of histogram values between 96˜255. The total area of the image is 100, therefore S1 is 9.64 and S2 is 90.36.

For the inverted image of shown in FIG. 3, the inversion decision unit 140 calculates distribution areas of two classes centering on the critical value T2. Curve B shows the luminosity histogram having a total area of the image is 100, wherein S1 amounts to 90.36 and S2 amounts to 9.64.

Through theses calculations, the inversion decision unit 140 can decide whether a series of frames transferred from the preview unit 120 correspond to an inverted image.

After deciding whether a series of frames transferred from the preview unit 120 are inverted, the inversion decision unit 140 stores the inversion information as a flag in a temporary buffer.

If the photograph selection unit 170 selects an image to be photographed from a series of the frames, the inverter unit 150 accesses the temporary buffer to read the flag value corresponding to the selected image.

If the flag value indicates that the image is inverted, the inverting unit 150 performs inverts the luminosity data of the image prior to transferring the image to the character recognition unit 180 and then converts the corresponding image to an image of a general document.

In performing the inversion process on the brightness of the image, the inverter unit 150 employs a comparison by an intermediate thresholding function, a histogram process using luminosity transform function or the like. For instance, a process of transforming brightness of an original pixel into new brightness can be performed based on a pre-designated function. For another instance, luminosity can be transformed based on a lookup table only.

The inversion decision unit 140 decides whether a series of images provided from the preview unit 120 is inverted and then records the decision result in the temporary buffer. When an image is selected, the decision result stored in the temporary buffer determines whether the image needs to be inverted.

Once the inversion processing of the image is completed, the character recognition unit 180 interprets the inverted image for character recognition. The character recognition unit 180, which recognizes characters of the image using a video analysis scheme, performs a process of acquiring character information through video division, video description and video object analysis.

For instance, the process of acquiring character information includes extraction of connecting elements, row extraction, character column extraction, separation of overlapped character columns, character column block extraction, character extraction and the like.

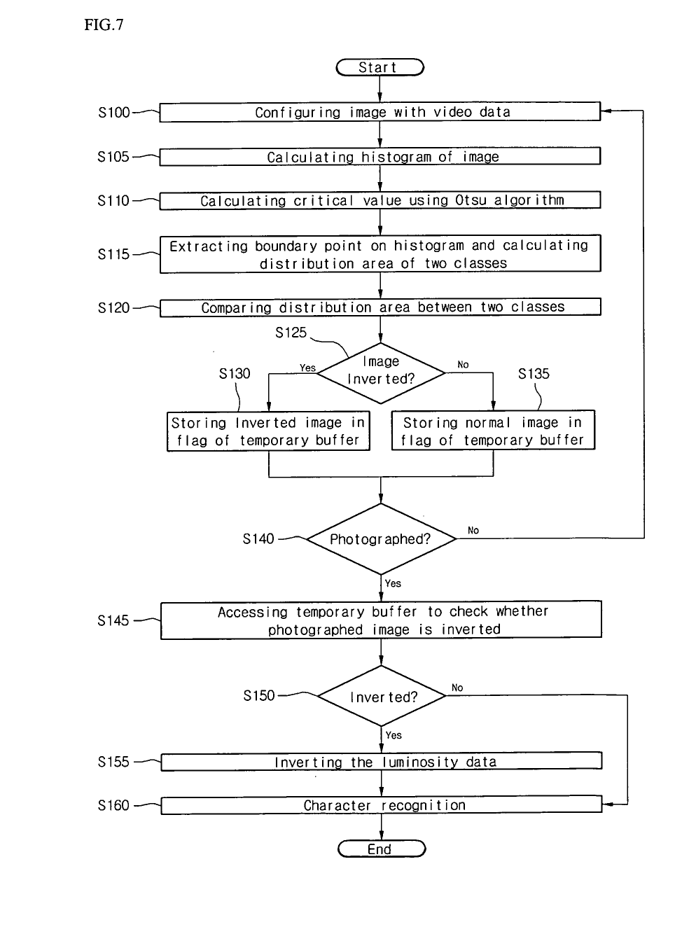

FIG. 7 is a flowchart of a method of inverting an image according to an embodiment of the present invention.

The video input unit 110 configures an image focused on the lens 112 with a series of video data and then delivers the video data to the preview unit 120.

The preview unit 120 displays the real time image on the video output unit 160 (S100).

The video processing unit 130 receives a series of images from the preview unit 120, calculates a histogram of each image, and calculates a critical value according to luminosity by applying the Otsu algorithm (S110).

The inverting unit 140 extracts a boundary point on the histogram according to the calculated critical value and then calculates distribution areas of two classes (S115).

The inversion decision unit 140 compares the distribution areas of the two classes (S120).

As a result of comparing the distribution areas of the two classes. If the area of a bright color space is greater by a prescribed value than a dark color space, the image of the corresponding frame is a general image. Otherwise, the image of the corresponding frame is an inverted image (S125).

According to the decision result, the inversion decision unit 140 records an inversion flag for each image in the temporary buffer (S130, S135).

If a user selects an image, the photograph selection unit 170 delivers the selected image to the inverting unit 150. The inverting unit 150 then accesses the temporary buffer to check a presence or non-presence of the selected frame (S140, S145).

Depending on the status of the inversion flag for a particular image, the inverting unit 150 enables the character recognition unit 180 to receive the document image directly (S150). If the selected frame is to be inverted, the inverting unit 150 processes luminosity inversion of each pixel of the image (S155) before sending the image to the character recognition unit 180.

Subsequently, the inverting unit 150 transfers the image having the inversed luminosity to the character recognition unit 180.

Finally, the character recognition unit 180 analyzes the transferred image thereby acquiring the information such as characters (S160). Accordingly, the present invention quickly performs the luminosity inversion on the image having the inversed luminosity, thereby efficiently acquiring character information.

Specifically, the present invention is advantageous in considerably enhancing the character recognition performance of a mobile communication terminal provided with the camera.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for inverting an image, the apparatus comprising:
a video processing unit calculating a critical value according to luminosity data of the image;
an inversion decision unit for dividing the luminosity data into two classes using the critical value, wherein the inversion decision unit determines whether the image is inverted according to a distribution of the two classes; and
an inverting unit for inverting the brightness of the video data according to whether or not the image is inverted.

2. The apparatus of claim 1, wherein the inversion decision unit determines whether each image of a series of images is inverted, and wherein the inverting unit inverts one or more selected images.

3. The apparatus of claim 1, wherein the video processing unit calculates the critical value from the luminosity data by using a global binary algorithm.

4. The apparatus of claim 3, wherein the global binary algorithm is the Otsu algorithm.

5. The apparatus of claim 1, wherein the inversion decision unit determines whether the image is inverted by comparing a number of pixels having low luminosity with a number of pixels having high luminosity, the number of pixels having high and low luminosity being responsive to the critical value.

6. The apparatus of claim 5, wherein the image is inverted when the number of pixels having low luminosity is greater than the number of pixels having high luminosity.

7. The apparatus of claim 5, wherein the inversion decision unit stores the determination of whether an image is inverted as a flag of a buffer and wherein the inverting unit inverts the brightness of the video data responsive to the flag.

8. A method of inverting an image, the method comprising the steps of:
calculating a critical value from luminosity data of the image;
dividing a distribution curve of the luminosity data into a first part and a second part, the division being responsive to the critical value;
determining whether the image is inverted by comparing the first part with the second part; and
inverting the luminosity data responsive to whether the image is inverted.

9. The method of claim 8 further comprising the steps of storing a flag indicating whether the image is inverted, and accessing the flag to determine whether the image is inverted.

10. The method of claim 8 further comprising the steps of determining whether each image of a series is inverted, and inverting selected images.

11. The method of claim 8, wherein the image is inverted when the number of pixels in the first part is greater than the number of pixels in the second part.

12. The method of claim 8, wherein the calculating the critical value uses a global binary algorithm.

13. The method of claim 12, wherein the global binary algorithm is the Otsu algorithm.

14. An apparatus for acquiring information in a mobile communication terminal, comprising:
a video input unit for converting an image received from a lens into video data, the video data comprises luminosity data;
a video output unit for displaying the image;
a preview unit coupled to the video input unit for providing video data to the video output unit;
a video processing unit coupled to the preview unit for calculating a critical value from the luminosity data;
an inversion decision unit for dividing the luminosity data into two classes using the critical value, wherein the inversion decision unit determines whether the image is inverted according to a distribution of the two classes;
a photograph selection unit for selecting images;
an inverting unit for inverting the brightness of the video data according to whether or not the image is inverted; and
a character recognition unit coupled to the photograph selection unit and the inversion decision unit for acquiring character information from the image.

15. The apparatus of claim 14, wherein the video input unit converts the image to video data having a series of frames.

16. The apparatus of claim 14, wherein the video processing unit calculates the critical value from the luminosity data by using a global binary algorithm.

17. The apparatus of claim 14, wherein the global binary algorithm is the Otsu algorithm.

18. The apparatus of claim 14, wherein the inversion decision unit determines whether the image is inverted by comparing a number of pixels having low luminosity with a number of pixels having high luminosity, the number of pixels having high and low luminosity being responsive to the critical value.

19. The apparatus of claim 18, wherein the image is inverted when the number of pixels having low luminosity is greater than the number of having high luminosity.

20. The apparatus of claim 18, wherein the inversion decision unit stores the determination of whether an image is inverted as a flag of a buffer and wherein the inverting unit inverts the brightness of the video data responsive to the flag.
